(19) United States
(12) Patent Application Publication
(10) Pub. No.: US 2004/0253891 A1
(43) Pub. Date: Dec. 16, 2004

(54) Composite structure for protective garment

(76) Inventors: Alan W. Schierenbeck, Dayton, OH (US); William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/894,187

(22) Filed: Jul. 19, 2004

Related U.S. Application Data
(63) Continuation-in-part of application No. 10/151,387, filed on May 20, 2002, now Pat. No. 6,806,215.
Application No. 10/151,387 is a continuation-in-part of application No. 09/659,957, filed on Sep. 12, 2000, now Pat. No. 6,658,670.

(51) Int. Cl. B32B 27/12; B32B 5/26

(52) U.S. Cl. 442/268; 442/76; 442/283; 442/285; 442/381; 442/394; 442/414; 442/417; 428/920

(57) ABSTRACT

For a protective garment, such as a protective coat for a firefighter, a composite structure comprises an outer shell, a moisture barrier within the outer shell, a moisture absorber, which absorber may incorporate a superabsorbent polymer, within the moisture barrier, and an innermost layer within the moisture barrier, wherein the innermost layer is hydrophobic but is moisture-pervious. In one contemplated embodiment, the innermost layer is made from synthetic, hydrophobic fibers, which fibers are woven so as to be moisture-pervious and which fibers are surfactant-treated so as to promote their being moisture-pervious. In another contemplated embodiment, the innermost layer is made from a sheet of a synthetic, hydrophobic material, which sheet is apertured so as to be moisture-pervious. In another contemplated embodiment, the innermost layer is made from natural fibers, which fibers have a hydrophobic finish and which fibers are woven so as to be moisture-pervious.

### CROSS-REFERENCE TO RELATED APPLICATION

This application is a continuation-in-part of U.S. patent application Ser. No. 10/151,387, which was filed on May 20, 2002, and the disclosure of which is incorporated herein by reference. U.S. patent application Ser. No. 10/151,387 is a continuation-in-part of U.S. patent application Ser. No. 09/659,957, which was filed on Sep. 12, 2000, now U.S. Pat. No. 6,658,670 B1, the disclosure of which is incorporated herein by reference.

### TECHNICAL FIELD OF THE INVENTION

This invention pertains to a composite structure for a protective garment, such as a pair of bunker pants for a firefighter, a bunker coat for a firefighter, or a glove for a firefighter. This invention contemplates that the composite structure incorporates, along with an outer shell, a moisture barrier within the outer shell, and a moisture absorber within the moisture barrier, an innermost layer, which is hydrophobic but which is moisture-pervious.

### BACKGROUND OF THE INVENTION

Commonly, in a firefighting environment, a firefighter wearing protective garments, such as bunker pants, a bunker coat, and gloves, sweats copiously within such garments, whereby the firefighter is exposed to severe stresses due to sweating, as well as to severe stresses due to firefighting. Such stresses are known to contribute significantly to fatigue, injuries, and fatalities among firefighters.

This invention addresses an ascertained need for a composite structure, from which such garments could be made and which would employ a superabsorbent polymer to absorb copious amounts of human sweat, whereby to reduce such stresses due to sweating.

Usage of a superabsorbent polymer in a composite structure for a protective garment, such as a protective garment for a firefighter, is disclosed in U.S. Pat. No. 5,885,912 to Bumberger, the disclosure of which is incorporated herein by reference.

### SUMMARY OF THE INVENTION

This invention provides a composite structure for a protective garment, such as a pair of bunker pants for a firefighter, a bunker coat for a firefighter, or a glove for a firefighter. The composite structure comprises an outer shell, a moisture barrier within the outer shell, a moisture absorber, which absorber may incorporate a superabsorbent polymer, within the moisture barrier, and an innermost layer within the moisture barrier, wherein the innermost layer is hydrophobic but is moisture-pervious. This invention does not preclude there being a thermally insulative layer between the moisture barrier and the moisture absorber.

In one contemplated embodiment, the innermost layer is made from synthetic, hydrophobic fibers, which fibers are woven so as to be moisture-pervious and which fibers are surfactant-treated so as to promote their being moisture-pervious. In another contemplated embodiment, the innermost layer is made from a sheet of a synthetic, hydrophobic material, which sheet is apertured so as to be moisture-pervious. In another contemplated embodiment, the innermost layer is made from natural fibers, which fibers have a hydrophobic finish and which fibers are woven so as to be moisture-pervious.

This invention also provides a protective garment, such as a pair of bunker pants for a firefighter, a bunker coat for a firefighter, or a glove for a firefighter, which garment comprises the composite structure described above.

Hereinbefore and hereinafter, moisture refers to any predominantly aqueous liquid, particularly but not exclusively water or human sweat. Hereinbefore and hereinafter, terms such as inner, outer, inwardly, and outwardly are employed from a standpoint of a wearer of a protective garment.

### BRIEF DESCRIPTION OF THE DRAWINGS

FIG. 1 and FIG. 2, respectively, are fragmentary, cross-sectional views of composite structures, each constituting one contemplated embodiment of this invention.

### DETAILED DESCRIPTION OF THE ILLUSTRATED EMBODIMENTS

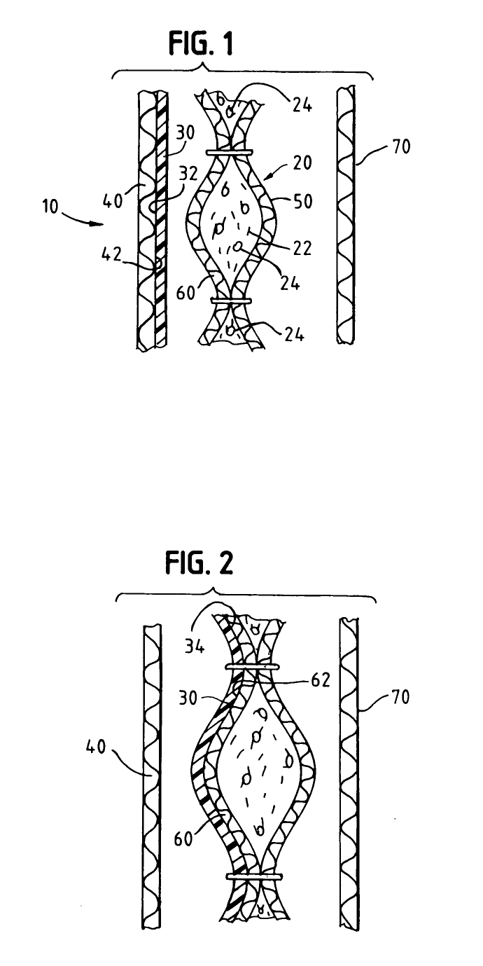

As shown in FIG. 1, a composite structure 10 for a protective garment, such as a pair of bunker pants for a firefighter, a bunker coat for a firefighter, or a glove for a firefighter, is made from fire-resistant materials and has a moisture absorber 20, a moisture barrier 30 disposed outwardly in relation to the moisture absorber 20, and an outer shell 40 disposed outwardly in relation to the moisture barrier 30. As explained below, the moisture absorber 20 incorporates a superabsorbent polymer, which may be a cross-linked polyacrylamide and which can absorb copious amounts of human sweat.

In the embodiment shown in FIG. 1, the moisture barrier 30 is affixed to the outer shell 40 so as to have surface-to-surface adhesion between an outer surface 32 of the moisture barrier 30 and an inner surface 42 of the outer shell 40. Thus, the moisture barrier 30 may be a moisture-impervious layer, e.g. a neoprene layer, which is laminated to the inner surface 42 of the outer shell 40, or a moisture-impervious layer, e.g. a Breathe Tex™ layer, which is coated on the inner surface 42 of the outer shell 40.

As shown in FIG. 1, the moisture absorber 20 has a fibrous matrix 22 incorporating particles 24 of the superabsorbent polymer. Alternatively, the fibrous matrix 22 incorporates fibers of the superabsorbent polymer. The fibrous matrix 22 is disposed between an inner cover 50, which is moisture-pervious, and an outer cover 60, which is moisture-pervious. The covers 50, 60, between which the fibrous matrix 22 is disposed, are textile layers, which are quilted to segregate discrete regions of the fibrous matrix 22.

Examples of superabsorbent polymers and processes for their incorporation into fibrous matrices are disclosed in prior patents including U.S. Pat. No. 3,670,731 to Harmon, U.S. Pat. No. 4,105,033 to Chaterjee et al, U.S. Pat. No. 4,235,237 to Mesek et al., U.S. Pat. No. 4,429,001 to Kolpin et al., U.S. Pat. No. 4,985,298 to Buckley et al., U.S. Pat. No. 5,087,513 to Kim, U.S. Pat. No. 5,328,759 to McCormack et al., and U.S. Pat. No. 5,419,955 to Ehrhardt et al., the disclosures of which are incorporated herein by reference.

In the embodiment shown in FIG. 2, the moisture barrier 30 is not affixed to the outer shell 40 so as to have surface-to-surface adhesion, as described above. Rather, the moisture barrier 20 is affixed to the outer cover 60 of the moisture absorber 20 so as to have surface-to-surface adhesion between an inner surface 34 of the moisture barrier 30 and an outer surface 62 of the outer cover 60 of the moisture absorber 20. Thus, the moisture barrier 30 may be a moisture-impervious layer, e.g. a neoprene layer, which is laminated to the outer surface 62 of the outer cover 60 of the moisture absorber 20, or a moisture-impervious layer, e.g. a Breathe Tex™ layer, which is coated on the outer cover 60 of the moisture absorber 20.

In each of the embodiments shown in FIGS. 3 and 4, a thermally insulative layer 70 is interposed between the moisture absorber 20 and the moisture barrier 30. The thermally insulative layer 70 has a conventional construction so as to comprise an inner cover 80, an outer cover 90, and a filler 100, which is thermally insulative and which is disposed between the covers 80, 90. The covers 80, 90, are quilted so as to segregate discrete regions of the filler 100.

In the embodiment shown in FIG. 3, the moisture barrier 30 is affixed to the outer shell 40, as in the embodiment shown in FIG. 1 and described above. In the embodiment shown in FIG. 4, the moisture barrier 40 is affixed to the outer cover 90 so as to have surface-to-surface adhesion between an outer surface 92 of the outer cover 90 and the inner surface 34 of the moisture barrier 30.

Optionally, a thermally insulative layer is provided between the moisture absorber 20 and the moisture barrier 30, as disclosed in U.S. patent application Ser. No. 10/151,387, supra.

In each of the embodiments shown and described, the composite structure 10 further comprises an innermost layer 70, as described below, which is hydrophobic but which is moisture-pervious.

In one contemplated embodiment, the innermost layer 70 is made from synthetic, hydrophobic fibers, such as polyamide fibers, which fibers are woven so as to be moisture-pervious and which fibers may be surfactant-treated so as to promote their being moisture-pervious. In another contemplated embodiment, the innermost layer 70 is made from a sheet of a synthetic, hydrophobic material, such as neoprene, which sheet is apertured so as to be moisture-pervious. In another contemplated embodiment, the innermost layer is made from natural fibers, such as wool fibers, which fibers have a hydrophobic finish and which fibers are woven so as to be moisture-pervious.

In each of the embodiments shown and described, because the innermost layer 70 is hydrophobic, the innermost layer 70 tends to be usually perceived as being dry by a wearer of the protective garment. Moreover, in each of the embodiments shown and described, the superabsorbent polymer can absorb copious amounts of human sweat, whereby to reduce sweat-caused stresses on a firefighter wearing a protective garment made from the composite material. Desirably, in each of the embodiments shown and described, a protective garment comprising the composite structure is made so that the composite structure can be easily removed for drying, or for laundering and drying, and so that the removed structure can be easily replaced.

1. For a protective garment, a composite structure comprising an outer shell, a moisture barrier within the outer shell, a moisture absorber within the moisture barrier, and an innermost layer within the moisture barrier, wherein the innermost layer is hydrophobic but is moisture-pervious.

2. The composite structure of claim 1 wherein the innermost layer is made from synthetic, hydrophobic fibers.

3. The composite structure of claim 1 wherein the innermost layer is made from synthetic, hydrophobic fibers, which fibers are woven so as to be moisture-pervious.

4. The composite structure of claim 1 wherein the innermost layer is made from synthetic, hydrophobic fibers, which fibers are woven so as to be moisture-pervious and which fibers are surfactant-treated so as to promote their being moisture-pervious.

5. The composite structure of claim 1 wherein the innermost layer is made from a sheet of a synthetic, hydrophobic material, which sheet is apertured so as to be moisture-pervious.

6. The composite structure of claim 1 wherein the innermost layer is made from natural fibers, which have a hydrophobic finish.

7. The composite structure of claim 1 wherein the innermost layer is made from natural fibers, which fibers have a hydrophobic finish and which fibers are woven so as to be moisture-pervious.

8. The composite structure of claim 1, 2, 3, 4, 5, 6 or 7 wherein the moisture absorber incorporates a superabsorbent polymer.

9. The composite structure of claim 1, 2, 3, 4, 5, 6, or 7 wherein the moisture absorber comprises a fibrous matrix incorporating a superabsorbent polymer.

10. A protective garment comprising the composite structure of claim 1, 2, 3, 4, 5, 6, or 7.

11. A protective garment comprising the composite structure of claim 1, 2, 3, 4, 5, 6, or 7 wherein the moisture absorber incorporates a superabsorbent polymer.

12. A protective garment comprising the composite structure of claim 1, 2, 3, 4, 5, 6, or 7 wherein the moisture absorber comprises a fibrous matrix incorporating a superabsorbent polymer.
